(19) United States
(12) Patent Application Publication
(10) Pub. No.: US 2015/0309723 A1
(43) Pub. Date: Oct. 29, 2015

(54) Systems and Methods for Notification Reminders

(71) Applicant: Tencent Technology (Shenzhen) Company Limited, Shenzhen (CN)

(72) Inventor: Haiyang Zhu, Shenzhen (CN)

(21) Appl. No.: 14/794,044

(22) Filed: Jul. 8, 2015

Related U.S. Application Data
(63) Continuation of application No. PCT/CN2014/079562, filed on Jun. 10, 2014.

(30) Foreign Application Priority Data
Jun. 19, 2013 (CN) 201310243075.8

(51) Int. Cl. G06F 3/0484

(52) U.S. Cl. CPC G06F 3/04847; G06F 3/04842

(57) ABSTRACT

Devices, terminals and methods are provided for notification reminders. For example, in response to a notification-reminder-triggering event being detected, current time information is obtained; one or more first notification reminder mechanisms corresponding to the current time information are obtained; and a notification reminder is generated based on at least information associated with the notification-reminder-triggering event and the first notification reminder mechanisms corresponding to the current time information.

### CROSS-REFERENCES TO RELATED APPLICATIONS

The application claims priority to Chinese Patent Application No. 201310243075.8, filed Jun. 19, 2013, incorporated by reference herein for all purposes.

### BACKGROUND OF THE INVENTION

Certain embodiments of the present invention are directed to electronics technology. More particularly, some embodiments of the invention provide systems and methods for notification reminders. Merely by way of example, some embodiments of the invention have been applied to mobile devices. But it would be recognized that the invention has a much broader range of applicability.

For mobile terminals, notification reminders are usually set up using voice reminders, vibration reminders or flashing reminders. Under different occasions, users can combine notification reminders of a terminal by setting different modes (e.g., standard mode, outdoors mode, conference mode, silent mode, etc.). However, a user often needs to manually switch between different modes. If the user inadvertently forgets to switch modes, incorrect notification reminders may be implemented, which may cause inconvenience to the user.

Hence it is highly desirable to improve the techniques for notification reminders.

### BRIEF SUMMARY OF THE INVENTION

According to one embodiment, a method is provided for notification reminders. For example, in response to a notification-reminder-triggering event being detected, current time information is obtained; one or more first notification reminder mechanisms corresponding to the current time information are obtained; and a notification reminder is generated based on at least information associated with the notification-reminder-triggering event and the first notification reminder mechanisms corresponding to the current time information.

According to another embodiment, a device for notification reminder includes: a time-acquisition module configured to, in response to a notification-reminder-triggering event being detected, obtain current time information, a notification-mechanism-acquisition module configured to obtain one or more first notification reminder mechanisms corresponding to the current time information, and a notification-reminder module configured to generate a notification reminder based on at least information associated with the notification-reminder-triggering event and the first notification reminder mechanisms corresponding to the current time information.

According to yet another embodiment, a non-transitory computer readable storage medium includes programming instructions for notification reminders. The programming instructions are configured to cause one or more data processors to execute certain operations. For example, in response to a notification-reminder-triggering event being detected, current time information is obtained; one or more first notification reminder mechanisms corresponding to the current time information are obtained; and a notification reminder is generated based on at least information associated with the notification-reminder-triggering event and the first notification reminder mechanisms corresponding to the current time information.

According to yet another embodiment, a terminal for notification reminder includes a device that includes: a time-acquisition module configured to, in response to a notification-reminder-triggering event being detected, obtain current time information, a notification-mechanism-acquisition module configured to obtain one or more first notification reminder mechanisms corresponding to the current time information, and a notification-reminder module configured to generate a notification reminder based on at least information associated with the notification-reminder-triggering event and the first notification reminder mechanisms corresponding to the current time information.

For example, the devices, terminals, devices and methods disclosed herein are configured to provide notification reminders using different notification reminder mechanisms according to current time information and adopt different notification reminder modes at different times according to user needs, so as to reduce user operations and provide better user experience.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for notification reminders according to one embodiment of the present invention.

FIG. 2 is a simplified diagram showing a method for notification reminders according to another embodiment of the present invention.

FIG. 3 is a simplified diagram showing a device for notification reminders according to one embodiment of the present invention.

FIG. 4 is a simplified diagram showing a notification-mechanism-acquisition module as part of the device as shown in FIG. 3 according to one embodiment of the present invention.

### DETAILED DESCRIPTION OF THE INVENTION

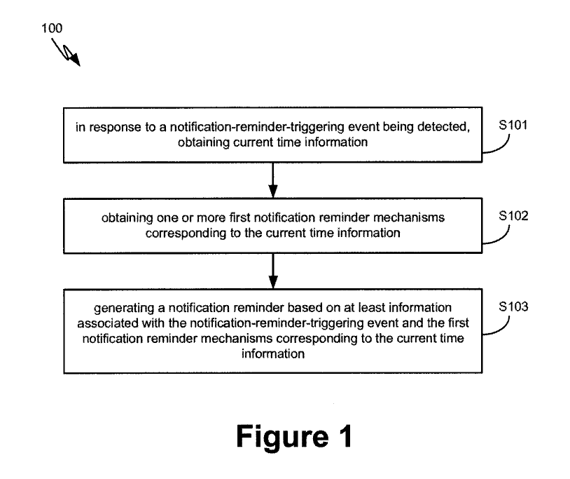

FIG. 1 is a simplified diagram showing a method for notification reminders according to one embodiment of the present invention. The diagram is merely an example, which should not unduly limit the scope of the claims. One of ordinary skill in the art would recognize many variations, alternatives, and modifications. The method 100 includes at least processes S101-S103.

According to one embodiment, the process S101 includes: in response to a notification-reminder-triggering event being detected, obtaining current time information. For example, the notification-reminder-triggering event includes incoming call reminders, text message reminders, new application notification reminders, or other proper reminders. In another example, after detecting the notification-reminder-triggering event, an electronic device registers the current time information based on a clock time of the electronic device or a current standard time obtained from the Internet. The time information may include one or more of the following: time period information, date information, workday information, or any other proper information. For example, the obtained time information is Wednesday, Jun. 5, 2013, 10:20, where Jun. 5, 2013 corresponds to the date information. The time period information indicates the current time period of the day and can be confirmed according to one or more pre-divided time periods. For example, a day is divided into four time periods: 0:00-6:00, 6:00-12:00, 12:00-18:00 and 18:00-24:00. The time period in the obtained time information corresponds to the third time period. The workday information indicates whether the current day is a workday. For example, Saturday and Sunday are set to be non-workdays, and Monday through Friday are set to be workdays. In another example, whether a day is a workday or not is determined based on preset statutory holiday arrangements.

According to another embodiment, the process S102 includes: obtaining one or more first notification reminder mechanisms corresponding to the current time information. Specifically, various types of time information are preset for different notification reminder mechanisms. Different notification reminder mechanisms can be set up to correspond to different time periods. For example, the time period of 0:00-6:00 of each day corresponds to a first notification reminder mechanism and other time periods correspond to a second notification reminder mechanism. Different dates can also be set up to correspond to various notification reminder mechanisms. As an example, first 15 days of each month correspond to a first notification reminder mechanism and other days correspond to a second notification reminder mechanism. Different time period information, date information and workday information can be set in any combination to correspond to various notification reminder mechanisms. For example, 9:00-18:00 of a workday corresponds to a first notification reminder mechanism, 0:00-12:00 of a non-workday corresponds to a second notification reminder mechanism, and other time periods correspond to a third notification reminder mechanism. In another example, a first non-workday of each month corresponds to the first notification reminder mechanism and other days correspond to the second notification reminder mechanism. An electronic device sets up notification reminder mechanisms and time information corresponding to various notification reminder mechanisms based on users settings, in some embodiments. Users can also set up notification reminder mechanisms and time information corresponding to various notification reminder mechanisms based on external configuration files, in certain embodiments. For example, the configuration files can be obtained from external storage devices through downloading, transferring or copying.

According to yet another embodiment, the process S103, generating a notification reminder based on at least information associated with the notification-reminder-triggering event and the first notification reminder mechanisms corresponding to the current time information. Specifically, different notification reminder modes are set for various notification-reminder-triggering events according to the notification reminder mechanisms. For example, an incoming call reminder includes a first ringtone, a first vibration mode and a first screen flashing mode. In another example, a text message reminder includes a second ringtone, a second vibration mode and a second screen flashing mode. In yet another example, a new application notification reminder includes a third ringtone, a third vibration mode and a third screen flashing mode. After the notification reminder mechanism corresponding to the current time information is obtained, notification reminders can be provided using notification reminder modes corresponding to different notification-reminder-triggering events, in some embodiments.

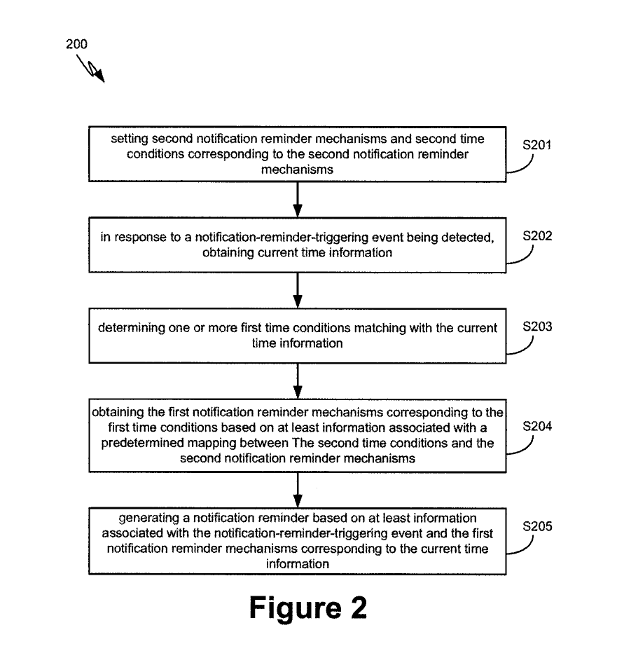

FIG. 2 is a simplified diagram showing a method for notification reminders according to another embodiment of the present invention. The diagram is merely an example, which should not unduly limit the scope of the claims. One of ordinary skill in the art would recognize many variations, alternatives, and modifications. The method 200 includes at least processes S201-S205.

According to one embodiment, the process S201 includes: setting second notification reminder mechanisms and second time conditions corresponding to the second notification reminder mechanisms. For example, an electronic device can set up notification reminder mechanisms and time conditions corresponding to various notification reminder mechanisms based on users settings. In another example, the electronic device can set up notification reminder mechanisms and time conditions corresponding to the notification reminder mechanisms based on external configuration files. As an example, the configuration files can be obtained from external storage devices through downloading, transferring or copying. The time conditions correspond to content of the time information, including one or more of the following: time period condition, date condition, workday condition, or other proper conditions. For example, a first time condition is 0:00-6:00 of each day and corresponds to a first notification reminder mechanism. A second time condition is 6:00-24:00 of each day and corresponds to a second notification reminder mechanism. In another example, the first time condition is first 15 days of each month and corresponds to the first notification reminder mechanism. The second time condition is other days of each month and corresponds to the second notification reminder mechanism. In yet another example, the first time condition is 9:00-18:00 of each workday and corresponds to the first notification reminder mechanism. The second time condition is 0:00-12:00 of each non-workday and corresponds to the second notification reminder mechanism. Other time periods correspond to a third time condition and a third notification reminder mechanism. In yet another example, the first time condition is the first non-workday of each month and corresponds to the first notification reminder mechanism, and other time periods correspond to the second time condition and the second notification reminder mechanism.

According to another embodiment, the process S202 includes: in response to a notification-reminder-triggering event being detected, obtaining current time information. For example, the notification-reminder-triggering event includes incoming call reminders, text message reminders, new application notification reminders, or other proper reminders. In another example, after detecting the notification-reminder-triggering event, an electronic device registers the current time information based on a clock time of the electronic device or a current standard time obtained from the Internet. The time information may include one or more of the following: time period information, date information, workday information, or any other proper information. For example, the obtained time information is Wednesday, Jun. 5, 2013, 10:20, where Jun. 5, 2013 corresponds to the date information. The time period information indicates the current time period of the day and can be contained according to one or more pre-divided time periods. For example, a day is divided into four time periods: 0:00-6:00, 6:00-12:00, 12:00-18:00 and 18:00-24:00. The time period in the obtained time information corresponds to the third time period. The workday information indicates whether the current day is a workday. For example, Saturday and Sunday are set to be non-workdays, and Monday through Friday are set to be workdays. In another example, whether a day is a workday or not is determined based on preset statutory holiday arrangements.

According to yet another embodiment, the process S203 includes: determining one or more first time conditions matching with the current time information. For example, the process S204 includes: obtaining the first notification reminder mechanisms corresponding to the first time conditions based on at least information associated with a predetermined mapping between the second time conditions and the second notification reminder mechanisms. The first notification reminder mechanism are deemed to correspond to the current time information, in some embodiments.

In one embodiment, the process S205 includes: generating a notification reminder based on at least information associated with the notification-reminder-triggering event and the first notification reminder mechanisms corresponding to the current time information. Specifically, different notification reminder modes are set for various notification-reminder-triggering events according to the notification reminder mechanisms. For example, an incoming call reminder includes a first ringtone, a first vibration mode and a first screen flashing mode. In another example, a text message reminder includes a second ringtone, a second vibration mode and a second screen flashing mode. In yet another example, a new application notification reminder includes a third ringtone, a third vibration mode and a third screen flashing mode. After the notification reminder mechanism corresponding to the current time information is obtained, notification reminders can be provided using notification reminder modes corresponding to different notification-reminder-triggering events, in some embodiments.

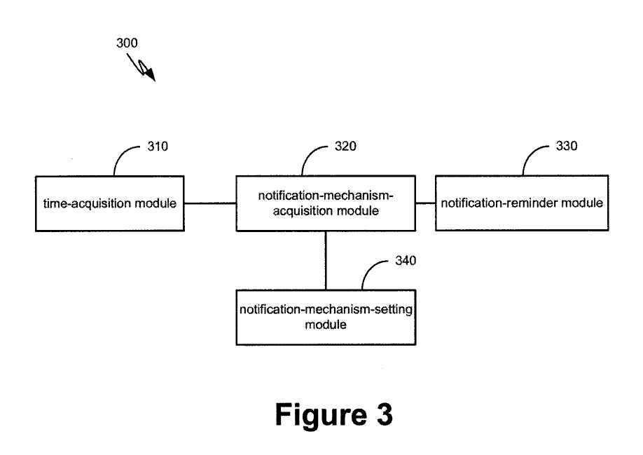

FIG. 3 is a simplified diagram showing a device for notification reminders according to one embodiment of the present invention. The diagram is merely an example, which should not unduly limit the scope of the claims. One of ordinary skill in the art would recognize many variations, alternatives, and modifications. The device 300 includes a time-acquisition module 310, a notification-mechanism-acquisition module 320, a notification-reminder module 330, and a notification-mechanism-setting module 340.

According to one embodiment, the time-acquisition module 310 is configured to, in response to a notification-reminder-triggering event being detected, obtain current time information. For example, the notification-reminder-triggering event includes incoming call reminders, text message reminders, new application notification reminders, or other proper reminders. In another example, after the notification-reminder-triggering event is detected, the time-acquisition module 310 acquires the current time information based on a clock time of the electronic device or a current standard time obtained from the Internet. The time information may include one or more of the following: time period information, date information, workday information, or any other proper information. For example, the obtained time information is Wednesday, Jun. 5, 2013, 10:20, where Jun. 5, 2013 corresponds to the date information. The time period information indicates the current time period of the day and can be confirmed according to one or more pre-divided time periods. For example, a day is divided into four time periods: 0:00-6:00, 6:00-12:00, 12:00-18:00 and 18:00-24:00. The time period in the obtained time information corresponds to the third time period. The workday information indicates whether the current day is a workday. For example, Saturday and Sunday are set to be non-workdays, and Monday through Friday are set to be workdays. In another example, whether a day is a workday or not is determined based on preset statutory holiday arrangements.

According to another embodiment, the notification-mechanism-acquisition module 320 is configured to obtain one or more first notification reminder mechanisms corresponding to the current time information. Specifically, the device 300 is configured to preset various types of time information for different notification reminder mechanisms. Different notification reminder mechanisms can be set up to correspond to different time periods. For example, the time period of 0:00-6:00 of each day corresponds to a first notification reminder mechanism and other time periods correspond to a second notification reminder mechanism. Different dates can also be set up to correspond to various notification reminder mechanisms. As an example, first 15 days of each month correspond to a first notification reminder mechanism and other days correspond to a second notification reminder mechanism. Different time period information, date information and workday information can be set in any combination to correspond to various notification reminder mechanisms. For example, 9:00-18:00 of a workday corresponds to a first notification reminder mechanism, 0:00-12:00 of a non-workday corresponds to a second notification reminder mechanism, and other time periods correspond to a third notification reminder mechanism. In another example, a first non-workday of each month corresponds to the first notification reminder mechanism and other days correspond to the second notification reminder mechanism.

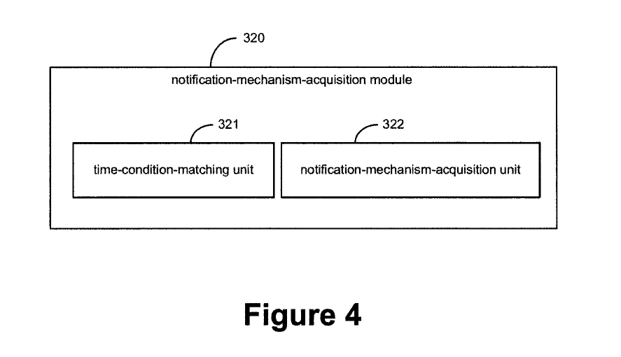

FIG. 4 is a simplified diagram showing a notification-mechanism-acquisition module as part of the device as shown in FIG. 3 according to one embodiment of the present invention. The diagram is merely an example, which should not unduly limit the scope of the claims. One of ordinary skill in the art would recognize many variations, alternatives, and modifications. The notification-mechanism-acquisition module 320 includes: a time-condition matching with unit 321 and a notification-mechanism-acquisition module 322.

According to one embodiment, the time-condition matching with unit 321 is configured to determine one or more time conditions matching with the current time information. Specifically, the time conditions correspond to content of the time information, including one or more of the following: time period condition, date condition, workday condition, or other proper conditions.

According to another embodiment, the notification-mechanism-acquisition module 322 is configured to obtain the notification reminder mechanisms corresponding to the time conditions based on at least information associated with a predetermined mapping between time conditions and notification reminder mechanisms. For example, the obtained notification reminder mechanisms correspond to the current time information. As an example, a first time condition is 0:00-6:00 of each day and corresponds to a first notification reminder mechanism. A second time condition is 6:00-24:00 of each day and corresponds to a second notification reminder mechanism. In another example, the first time condition is first 15 days of each month and corresponds to the first notification reminder mechanism. The second time condition is other days of each month and corresponds to the second notification reminder mechanism. In yet another example, the first time condition is 9:00-18:00 of each workday and corresponds to the first notification reminder mechanism. The second time condition is 0:00-12:00 of each non-workday and corresponds to the second notification reminder mechanism. Other time periods correspond to a third time condition and a third notification reminder mechanism. In yet another example, the first time condition is a first non-workday of each month and corresponds to the first notification reminder mechanism, and other time periods correspond to the second time condition and the second notification reminder mechanism.

Referring back to FIG. 3, the notification-reminder module 330 is configured to generate a notification reminder based on at least information associated with the notification-reminder-triggering event and the first notification reminder mechanisms corresponding to the current time information, according to some embodiments. Specifically, different notification reminder modes are set for various notification-reminder-triggering events according to the notification reminder mechanisms. For example, an incoming call reminder includes a first ringtone, a first vibration mode and a first screen flashing mode. In another example, a text message reminder includes a second ringtone, a second vibration mode and a second screen flashing mode. In yet another example, a new application notification reminder includes a third ringtone, a third vibration mode and a third screen flashing mode. After the notification reminder mechanism corresponding to the current time information is obtained, the notification-reminder module 330 is configured to provide notification reminders using notification reminder modes corresponding to different notification-reminder-triggering events, in some embodiments.

In one embodiment, the device 300 further includes a notification-mechanism-setting module 340 configured to set up the second notification reminder mechanisms and the second time conditions. For example, the notification-mechanism-setting module 340 can set up notification reminder mechanisms and time conditions corresponding to the various notification reminder mechanisms based on users settings. In another example, the notification-mechanism-setting module 340 can set up notification reminder mechanisms and time conditions corresponding to various notification reminder mechanisms based on external configuration files. As an example, the configuration files can be obtained from external storage devices through downloading, transferring or copying.

In some embodiments, a terminal that includes the device 300 is implemented for providing notification reminders. According to certain embodiments, the device 300 includes a personal computer, a tablet computer, a cell phone, a smart phone, a laptop, or other suitable electronic devices. The method 100 and/or the method 200 are implemented using the device 300, according to some embodiments.

According to one embodiment, a method is provided for notification reminders. For example, in response to a notification-reminder-triggering event being detected, current time information is obtained; one or more first notification reminder mechanisms corresponding to the current time information are obtained; and a notification reminder is generated based on at least information associated with the notification-reminder-triggering event and the first notification reminder mechanisms corresponding to the current time information. For example, the method is implemented according to at least FIG. 1 and/or FIG. 2.

According to another embodiment, a device for notification reminder includes: a time-acquisition module configured to, in response to a notification-reminder-triggering event being detected, obtain current time information, a notification-mechanism-acquisition module configured to obtain one or more first notification reminder mechanisms corresponding to the current time information, and a notification-reminder module configured to generate a notification reminder based on at least information associated with the notification-reminder-triggering event and the first notification reminder mechanisms corresponding to the current time information. For example, the device is implemented according to at least FIG. 3.

According to yet another embodiment, a non-transitory computer readable storage medium includes programming instructions for notification reminders. The programming instructions are configured to cause one or more data processors to execute certain operations. For example, in response to a notification-reminder-triggering event being detected, current time information is obtained; one or more first notification reminder mechanisms corresponding to the current time information are obtained; and a notification reminder is generated based on at least information associated with the notification-reminder-triggering event and the first notification reminder mechanisms corresponding to the current time information. For example, the storage medium is implemented according to at least FIG. 1 and/or FIG. 2.

According to yet another embodiment, a terminal for notification reminder includes a device that includes: a time-acquisition module configured to, in response to a notification-reminder-triggering event being detected, obtain current time information, a notification-mechanism-acquisition module configured to obtain one or more first notification reminder mechanisms corresponding to the current time information, and a notification-reminder module configured to generate a notification reminder based on at least information associated with the notification-reminder-triggering event and the first notification reminder mechanisms corresponding to the current time information. For example, the terminal is implemented according to at least FIG. 3.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A method for notification reminders comprising:
in response to a notification-reminder-triggering event being detected, obtaining current time information;
obtaining one or more first notification reminder mechanisms corresponding to the current time information; and
generating a notification reminder based on at least information associated with the notification-reminder-triggering event and the first notification reminder mechanisms corresponding to the current time information.

2. The method of claim 1, wherein the obtaining one or more first notification reminder mechanisms corresponding to the current time information includes:
determining one or more first time conditions matching with the current time information;
obtaining the first notification reminder mechanisms corresponding to the first time conditions based on at least information associated with a predetermined mapping between second time conditions and second notification reminder mechanisms.

3. The method of claim 2, further comprising:
setting up the second notification reminder mechanisms and the second time conditions.

4. The method of claim 1, wherein the current time information includes one or more of the following: time period information, date information and workday information.

5. The method of claim 1, wherein the notification-reminder-triggering event includes one or more of the following: an incoming call reminder, a text message reminder, and a new application notification reminder.

6. A device for notification reminder comprising:
a time-acquisition module configured to, in response to a notification-reminder-triggering event being detected, obtain current time information;
a notification-mechanism-acquisition module configured to obtain one or more first notification reminder mechanisms corresponding to the current time information; and
a notification-reminder module configured to generate a notification reminder based on at least information associated with the notification-reminder-triggering event and the first notification reminder mechanisms corresponding to the current time information.

7. The device of claim 6, wherein the notification-mechanism-acquisition module includes:
a time-condition-matching unit configured to determine one or more first time conditions matching with the current time information; and
a notification-mechanism-acquisition unit configured to obtain the first notification reminder mechanisms corresponding to the first time conditions based on at least information associated with a predetermined mapping between second time conditions and second notification reminder mechanisms.

8. The device of claim 7, further comprising:
a notification-mechanism-setting module configured to set up the second notification reminder mechanisms and the second time conditions.

9. The device of claim 6, wherein the current time information includes one or more of the following: time period information, date information and workday information.

10. The device of claim 6, wherein the notification-reminder-triggering event includes one or more of the following: an incoming call reminder, a text message reminder, and a new application notification reminder.

11. The device of claim 6, further comprising:
one or more data processors; and
a computer-readable storage medium;
wherein the time-acquisition module, the notification-mechanism-acquisition module, the safety verification module, and the notification-reminder module are stored in the storage medium and configured to be executed by the one or more data processors.

12. A non-transitory computer readable storage medium comprising programming instructions for notification reminders, the programming instructions configured to cause one or more data processors to execute operations comprising:
in response to a notification-reminder-triggering event being detected, obtaining current time information;
obtaining one or more first notification reminder mechanisms corresponding to the current time information; and
generating a notification reminder based on at least information associated with the notification-reminder-triggering event and the first notification reminder mechanisms corresponding to the current time information.

13. (canceled)
